(19) United States
(12) Patent Application Publication
(10) Pub. No.: US 2024/0429002 A1
(43) Pub. Date: Dec. 26, 2024

(54) Switching Apparatus

(71) Applicant: Alps Alpine Co., Ltd., Tokyo (JP)

(72) Inventor: Takaki TANAKA, Miyagi-ken (JP)

(21) Appl. No.: 18/828,048

(22) Filed: Sep. 9, 2024

Related U.S. Application Data
(63) Continuation of application No. PCT/JP2023/001998, filed on Jan. 24, 2023.

(30) Foreign Application Priority Data
Mar. 29, 2022 (JP) 2022-053508

(51) Int. Cl. H01H 9/04

(52) U.S. Cl. CPC H01H 9/04

(57) ABSTRACT

A switching apparatus includes an outer case including an opening that is open in a first direction, an inner case disposed in the outer case, a switch unit provided in the inner case, and a sealing member. The outer case includes a recessed portion around the opening and an attaching portion extending in a flange shape around the recessed portion. The inner case includes an insertion portion in the outer case, a plate-like flange connected to the insertion portion, and a connecting terminal at an opposite side of the flange from the insertion portion, the connecting terminal protruding in the first direction. The sealing member is disposed astride a surface of the flange where the connecting terminal is provided and an attaching surface around the recessed portion of the attaching portion, the sealing member covering an exposed portion of the recessed portion located around the flange.

### CLAIM OF PRIORITY

This application is a Continuation of International Application No. PCT/JP2023/001998 filed on Jan. 24, 2023, which claims benefit of Japanese Patent Application No. 2022-053508 filed on Mar. 29, 2022. The entire contents of each application noted above are hereby incorporated by reference.

### BACKGROUND OF THE INVENTION

### 1. Field of the Invention

The present invention relates to switching apparatuses.

### 2. Description of the Related Art

Japanese Unexamined Patent Application Publication No. 2017-130277 discloses a configuration for switching apparatuses in which the switch unit is driven by a drive member, which is rotatably supported by the case, by pushing an operating portion of the cover to rotate the drive member.

Japanese Unexamined Patent Application Publication No. 2020-020109 discloses a back-door handle apparatus in which displacement of the switch nob and contact of the switch nob with the outer cover, which could hinder assembly, are prevented, and a method for manufacturing the same.

In attaching a switching apparatus to a mating member, it is important to ensure water-proofness, drip-proofness, and dust-proofness between the switching apparatus and the mating member. For this reason, to operate the switch element disposed in the case from the outside of the case, an elastomeric material having elasticity is provided at the opening of the case to enable the switch element in the case to be operated using the elasticity of the elastomeric material.

To provide a case made of a rigid plastic material with an elastomeric material having elasticity, two-color molding is performed. For the two-color molding, a rib made of an elastomeric material having elasticity is formed on the mounting surface of the outer case for attaching the mating member. In attaching the case to the mating member, the rib is compressed to ensure the water-proofness of the mounting surface.

The sealing between such a case and a mating member requires stable sealing performance over the entire range of the seal surface. If the case has a double structure with an outer case and an inner case, it is important to ensure the sealing performance of the joint of the outer case and the inner case. In the configuration where the rib is formed from an elastomeric material by two-color molding, since the processing time for part, such as the shot cycle, increases, it is desirable to enhance manufacturability and quality stability.

### SUMMARY OF THE INVENTION

The present invention provides a switching apparatus that is easy to manufacture and that has stable quality, sufficient water-proofness, drip-proofness, and dust-proofness.

In a first aspect of the present invention, a switching apparatus includes an outer case including an opening that is open in a first direction, an inner case disposed in the outer case through the opening, a switch unit provided in the inner case, and a sealing member, wherein the outer case includes a recessed portion provided around the opening and an attaching portion extending in a flange shape around the recessed portion, wherein the inner case includes an insertion portion disposed in the outer case through the opening, the switch unit being disposed in the insertion portion, a plate-like flange connected to the insertion portion, and a connecting terminal provided at an opposite side of the flange from the insertion portion, the connecting terminal protruding in the first direction, and wherein the sealing member is disposed astride a surface of the flange where the connecting terminal is provided and an attaching surface around the recessed portion of the attaching portion, the sealing member covering an exposed portion of the recessed portion located around the flange as viewed in the first direction.

With this configuration, using the sealing member provided on the attaching portion to keep the watertightness with the mating member also as a watertight member between the outer case and the inner case can reduce the components of the switching apparatus and enhance the ease of manufacture and quality stability of the switching apparatus.

In the switching apparatus, the sealing member may include a portion made of a closed-cell sponge material. The portion of the sealing member made of a closed-cell sponge material ensures watertightness, and compressing the foamed portion allows for greater compression compared with a non-foamed member. For this reason, even if the switching apparatus attached to the mating member is used in a vibration environment, high watertightness is easily maintained.

The switching apparatus may further include a bonding layer on a surface of the sealing member facing the attaching portion and the flange. Providing the bonding layer also allows the sealing member to be fixed to the outer case and the inner case. The bonding layer also contributes to enhancing watertightness. The adhesive of the bonding layer may be a pressure-sensitive adhesive (a sticky agent).

In the switching apparatus, the attaching portion may include, at a portion not facing the sealing member, a fixing portion for fixing with a mating member. Although the fixing portion may come into direct-contact with the mating member, the sealing member is securely interposed between the attaching portion and the mating member. This configuration makes it easy to maintain the watertightness of the sealing member.

In the switching apparatus, the flange may include an opposing portion facing the mating member via the sealing member when attached to the mating member, and the opposing portion may include a protruding portion protruding from the recessed portion in the first direction in a state before being attached to the mating member. The protruding portion is pushed by the mating member during the attachment. For this reason, a portion of the sealing member facing the protruding portion is compressed more than the other portion, thereby increasing watertightness. This can therefore decrease the possibility that water enters the interior of the mating member. From the perspective of ensuring high watertightness, the protruding portion is preferably provided around the entire periphery of the flange as viewed in the first direction.

In the switching apparatus, the sealing member may include a through-hole passing therethrough in the first direction, and the connecting terminal may be passed through the through-hole. Since the connecting terminal is passed through the through-hole of the sealing member, the sealing member encloses the periphery of the connecting terminal, thereby making it easy to ensure watertightness around the connecting terminal.

In the switching apparatus, a side surface of the through-hole may be in contact with a protruding side of the connecting terminal. Since the side surface of the through-hole and the protruding side of the connecting terminal are in contact with each other, the shortest distance between the outer edge and the inner edge of the seal surface of the sealing member (corresponding to the creepage distance for isolation) can be increased, thereby improving the watertightness.

In the switching apparatus, the surface of the sealing member facing the mating member may include a non-contact portion that does not come into contact with the mating member around the through-hole as viewed in the first direction. The fact that the sealing member has such a non-contact portion indicates that the mating member has an opening wider than the through-hole. As the edge (the edge portion) of the opening comes into contact with the sealing member, the contact pressure increases. Therefore, even if water infiltrates between the sealing member and the mating member, infiltration of water to the protruding side of the connecting terminal of the mating member can be prevented by the edge (edge portion) with high contact pressure.

In the switching apparatus, a whole of the non-contact portion may overlap with the flange as viewed in the first direction. With this configuration, the edge (edge portion) of the opening of the mating member pushes the flange via the sealing member. Since the contact pressure on the sealing member is highest at the edge (edge portion), the contact pressure between the inner case and the outer case can be increased, thereby enhancing watertightness.

In the switching apparatus, a whole of the flange may overlap with the non-contact portion as viewed in the first direction. With this configuration, the edge (edge portion) of the opening of the mating member pushes the attaching surface via the sealing member. The sealing member may be most compressed at the portion in contact with the edge (edge portion), in which case watertightness is highest at this portion. For this reason, disposing the portion with the highest watertightness around the flange as viewed in the first direction allows for decreasing the possibility of water ingress into the recessed portion.

### BRIEF DESCRIPTION OF THE DRAWINGS

FIG. 1 is a perspective view of an example of a switching apparatus according to a first embodiment;

FIG. 2 is an exploded perspective view of an example of the switching apparatus according to the first embodiment;

FIG. 3 is a perspective cross-sectional view of an example of the switching apparatus according to the first embodiment;

FIG. 4 is a cross-sectional view of an example of the switching apparatus according to the first embodiment;

FIG. 5 is a fragmentary enlarged cross-sectional view of the switching apparatus according to the first embodiment;

FIG. 6 is a cross-sectional view of an example of the fixing portion of the switching apparatus;

FIG. 7A is a fragmentary cross-sectional view illustrating a state before the switching apparatus is attached;

FIG. 7B is a fragmentary cross-sectional view illustrating a state after the switching apparatus is attached;

FIG. 8 is a cross-sectional view of an example of a switching apparatus according to a second embodiment;

FIG. 9 is a fragmentary enlarged cross-sectional view of the switching apparatus according to the second embodiment;

FIG. 10 is a perspective view of an example of a switching apparatus according to a third embodiment;

FIG. 11 is a perspective cross-sectional view of an example of the switching apparatus according to the third embodiment;

FIG. 12 is a fragmentary enlarged perspective cross-sectional view of the switching apparatus according to the third embodiment;

FIG. 13 is a schematic diagram illustrating the positional relationship among the flange, the sealing member, and the mating member as viewed in the X-direction;

FIG. 14 is a schematic diagram illustrating the positional relationship among the flange, the sealing member, and the mating member as viewed in the X-direction;

FIG. 15 is a perspective view of an example of a switching apparatus according to a fourth embodiment;

FIG. 16 is a perspective view of the switching apparatus according to the fourth embodiment illustrating a state in which a connector is connected thereto;

FIG. 17 is a perspective cross-sectional view of the switching apparatus according to the fourth embodiment illustrating a state in which a connector is connected thereto; and

FIG. 18 is a fragmentary enlarged perspective cross-sectional view of the switching apparatus according to the fourth embodiment.

### DESCRIPTION OF THE PREFERRED EMBODIMENTS

Embodiments of the present invention will be described in detail hereinbelow with reference to the accompanying drawings. In the following description, like components are identified by the same reference signs, and the description of previously explained components will be omitted as appropriate.

### First Embodiment

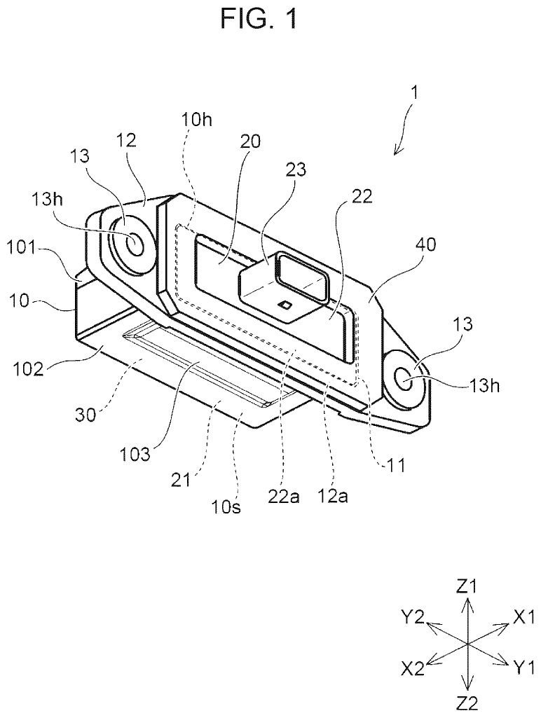

FIG. 1 is a perspective view of an example of a switching apparatus according to a first embodiment.

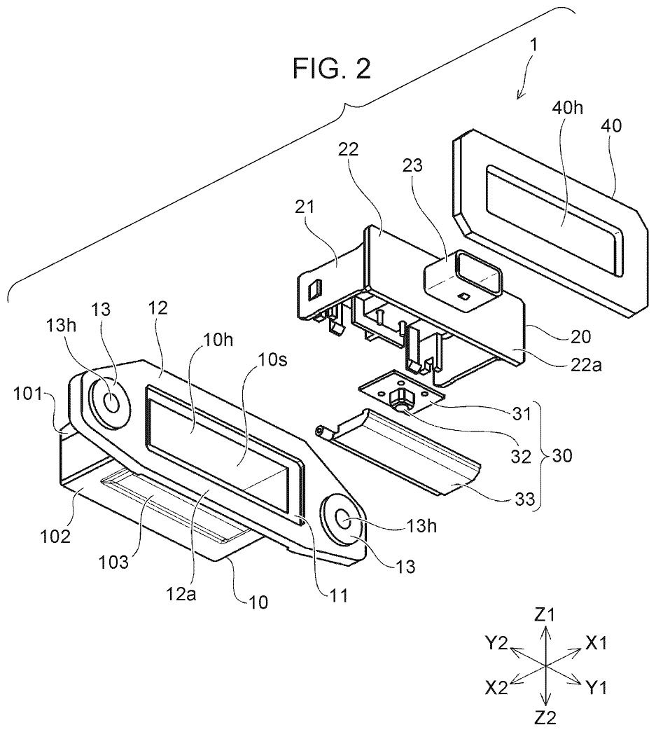

FIG. 2 is an exploded perspective view of an example of the switching apparatus according to the first embodiment.

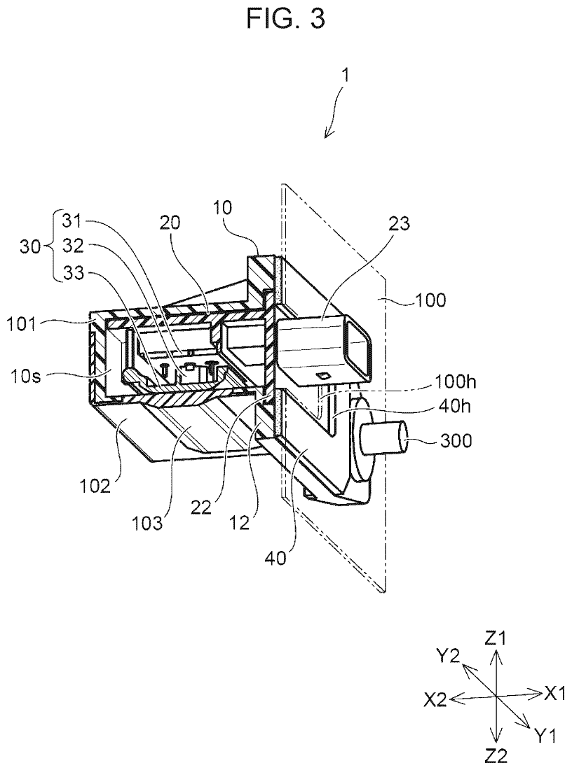

FIG. 3 is a perspective cross-sectional view of an example of the switching apparatus according to the first embodiment.

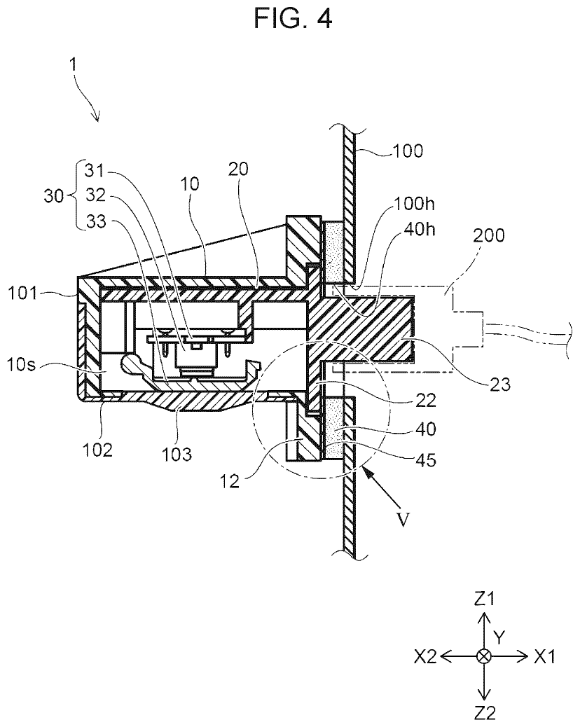

FIG. 4 is a cross-sectional view of an example of the switching apparatus according to the first embodiment.

The switching apparatus 1 according to this embodiment is operated, for example, when the trunk door of a vehicle is opened. By turning on the switching apparatus 1, the latch is released, and the trunk door can be opened.

The switching apparatus 1 includes an outer case 10, an inner case 20, a switch unit 30, and a sealing member 40. The outer case 10 includes an opening 10h that is open in a first direction. In the description of the embodiments, the first direction is defined as the X-direction, one of the directions perpendicular to the X-direction is defined as the Y-direction, and the direction perpendicular to the X-direction and the Y-direction is defined as the Z-direction. Of the X-direction, one direction is defined as the X1-direction, and the other direction is defined as the X2-direction. Of the Y-direction, one direction is defined as the Y1-direction, and the other direction is defined as the Y2-direction. Of the Z-direction, one direction is defined as the Z1-direction, and the other direction is defined as the Z2-direction.

The outer case 10 is a box-shaped member made of, for example, resin. The opening 10h of the outer case 10 has a substantially rectangular shape and is open in the X1-direction. The outer case 10 has therein a housing space 10s that communicates with the opening 10h. The outer case 10 has a recessed portion 11 provided around the opening 10h and an attaching portion 12 extending in a flange shape around the recessed portion 11. The recessed portion 11 is a level-difference portion provided between the attaching portion 12 and the edge of the opening 10h. Fixing portions 13 may be provided on both sides of the attaching portion 12 in the Y-direction. Each fixing portion 13 may have a through-hole 13h through which a bolt 300 for fastening the switching apparatus 1 to the mating member 100 (for example, the door panel of a vehicle) is passed.

The outer case 10 includes a hard resin portion 101 and a soft resin portion 102. The hard resin portion 101 is formed of a hard resin material to form the upper portion (Z1 side) of the outer case 10. The soft resin portion 102 is formed of a soft resin material such as elastomer to form the lower portion (Z2 side) of the outer case 10. The outer case 10 is integrally formed of the hard resin portion 101 and the soft resin portion 102 by two-color molding.

The bottom surface (Z2 side) of the outer case 10 is provided with an operating portion 103 having, for example, a (an oblong rectangular) rectangular shape, raised downward (in the Z2-direction). The operating portion 103 is provided under a lever 33 disposed in the housing space 10s (in the Z2-direction) so as to be overlapped therewith in the Z-direction.

In other words, the surface on the housing space 10s side of the operating portion 103 is in close-contact with the lower surface of the lever 33 (see FIGS. 3 and 4). This allows the operating portion 103 to be elastically deformed when pushed, thereby pushing the lever 33 upward (Z1-direction).

The inner case 20 is disposed in the housing space 10s in the outer case 10 through the opening 10h of the outer case 10. The inner case 20 is a substantially box-shaped member made of, for example, resin. The inner case 20 includes an insertion portion 21 disposed in the housing space 10s in the outer case 10 through the opening 10h. The switch unit 30 is disposed in the insertion portion 21.

The inner case 20 includes a plate-like flange 22 connected to the insertion portion 21. The flange 22 is shaped like a flat plate along the Y-Z plane and is fitted in the recessed portion 11 of the outer case 10 when the inner case 20 is disposed in the housing space 10s through the opening 10h of the outer case 10. When the plate-like flange 22 is fitted in the recessed portion 11, the opening 10h is closed by the flange 22.

The inner case 20 includes a connecting terminal 23. The connecting terminal 23 is provided on the opposite side of the flange 22 from the insertion portion 21 and protrudes in the first direction (X1-direction). The connecting terminal 23 is provided in a square pole shape at about the center of the flange 22. Inside the connecting terminal 23, an electrode that conducts with a switch element 32 of the switch unit 30 is provided. By fitting an external connector 200 (see FIG. 4) on the connecting terminal 23, the electrode of the connector 200 and the electrode of the connecting terminal 23 come into contact with each other, allowing electrical conduction between the switch element 32 and the external component.

The switch unit 30 is provided in the insertion portion 21 of the inner case 20. The switch unit 30 includes a circuit board 31, the switch element 32 mounted on the circuit board 31, and the lever 33 pivotably attached to the inner case 20. The lever 33 is a substantially rectangular member extending in the Y-direction and is supported so as to be rotatable in the Y-direction, for example, at the end on the X2 side. The lever 33 is disposed between the operating portion 103 and the switch element 32, with the inner case 20 housed in the outer case 10. This configuration allows the lever 33 in the outer case 10 to pivot toward the switch element 32 via the operating portion 103 which is elastically deformed when pushed in the Z1-direction from the outside of the outer case 10, thereby pushing the switch element 32.

The sealing member 40 is disposed astride a surface 22a of the flange 22 of the inner case 20 on the side where the connecting terminal 23 is provided and an attaching surface 12a around the recessed portion 11 of the attaching portion 12 of the outer case 10. The sealing member 40 is configured to cover the exposed portion of the recessed portion 11 located around the flange 22 as viewed in the X-direction.

The sealing member 40 has a through-hole 40h passing therethrough in the X-direction. In other words, the sealing member 40 is a ring-shaped member with a predetermined width having the through-hole 40h at the center. The sealing member 40 is attached so as to close the gap between the edge of the flange 22 of the inner case 20 fitted in the recessed portion 11 and the edge on the attaching surface 12a side of the recessed portion 11, with the connecting terminal 23 passed through the through-hole 40h. The sealing member 40 is made of, for example, a closed-cell sponge material. The closed-cell sponge material may be provided in part of the sealing member 40.

The switching apparatus 1 having such a configuration is attached to the mating member 100. The mating member 100 has a hole 100h through which the connecting terminal 23 protruding from the inner case 20 of the switching apparatus 1 in the X1-direction is passed. The switching apparatus 1 is attached to the surface of the mating member 100 on the X2 side such that the connecting terminal 23 of the switching apparatus 1 protrudes from the hole 100h of the mating member 100 in the X1-direction. The connector 200 is fitted on the connecting terminal 23.

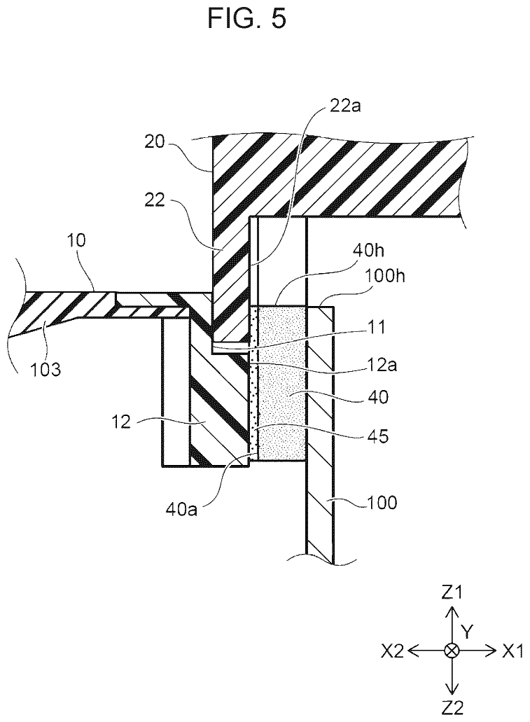

FIG. 5 is a fragmentary enlarged cross-sectional view of the switching apparatus according to the first embodiment. FIG. 5 is an enlarged cross-sectional view of portion A illustrated in FIG. 4.

A bonding layer 45 may be provided on a surface 40a of the sealing member 40 facing the attaching portion 12 and the flange 22. The adhesive of the bonding layer 45 may be a pressure-sensitive adhesive (a sticky agent). When the switching apparatus 1 is attached to the mating member 100, the sealing member 40 is interposed between the attaching portion 12 and the flange 22, and the mating member 100, and serves as watertightness between the mating member 100 and the switching apparatus 1.

The sealing member 40 also functions as a watertight member between the outer case 10 and the inner case 20. In other words, since the sealing member 40 is disposed astride the surface 22a of the flange 22 and the attaching surface 12a of the attaching portion 12 so as to cover the exposed portion of the recessed portion 11 in a ring shape as viewed in the X-direction, the gap between the outer case 10 and the inner case 20 fitted in the recessed portion 11 of the outer case 10 is closed.

Using the sealing member 40 provided on the attaching portion 12 to keep the watertightness with the mating member 100 also as a watertight member between the outer case 10 and the inner case 20 in this manner can reduce the components of the switching apparatus 1 and enhance the ease of manufacture and quality stability of the switching apparatus 1. Furthermore, there is no need to provide a rib serving as a seal in manufacturing the outer case 10 by two-color molding, thereby preventing an increase in processing time for parts such as the shot cycle.

The portion of the sealing member 40 made of a closed-cell sponge material ensures watertightness, and compression of the foamed portion allows for greater compression compared with a non-foamed member. For this reason, even if the switching apparatus 1 attached to the mating member 100 is used in a vibration environment, high watertightness is easily maintained.

Providing the bonding layer 45 on the surface 40a of the sealing member 40 allows the sealing member 40 to be tightly fixed to the outer case 10 and the inner case 20, further enhancing the watertightness between the sealing member 40, and the outer case 10 and the inner case 20.

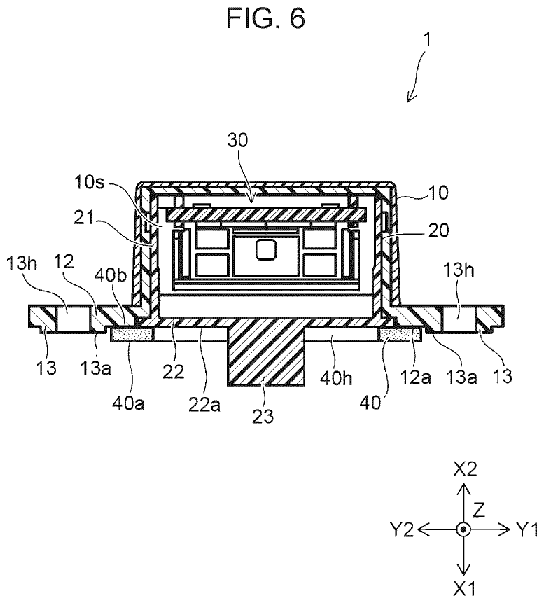

FIG. 6 is a cross-sectional view of an example of the fixing portion of the switching apparatus.

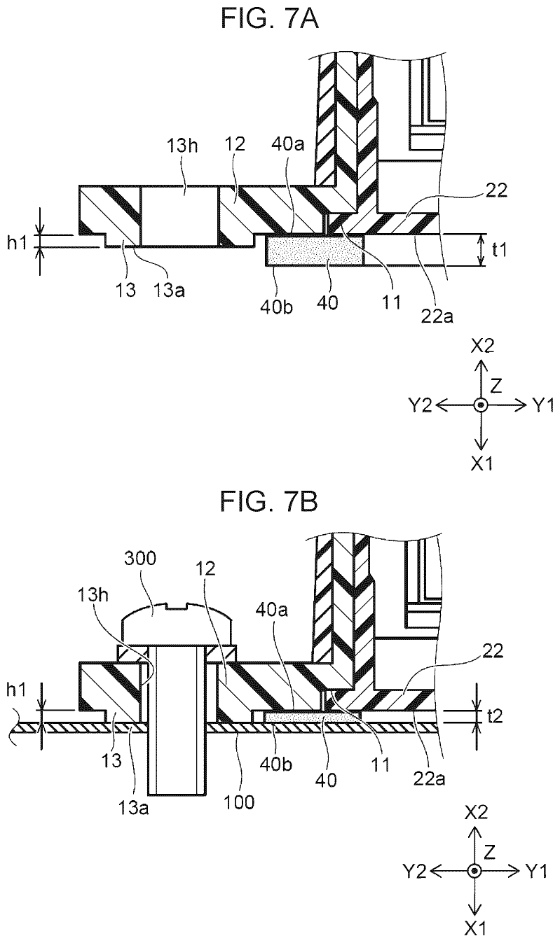

FIG. 7A is a fragmentary cross-sectional view illustrating a state before the switching apparatus is attached.

FIG. 7B is a fragmentary cross-sectional view illustrating a state after the switching apparatus is attached.

The fixing portion 13 has a protruding surface 13a protruding from the attaching surface 12a of the attaching portion 12 of the outer case 10 in the X1-direction. As illustrated in FIG. 7A, before the switching apparatus 1 is attached to the mating member 100, the protruding surface 13a of the fixing portion 13 protrudes in the X1-direction relative to the surface 40a facing the flange 22 of the sealing member 40, but does not protrude in the X1-direction relative to an opposing surface 40b of the sealing member 40 (set back in the X2-direction). In other words, the protrusion height h1 of the fixing portion 13 is smaller than the thickness t1 of the sealing member 40.

As illustrated in FIG. 7B, the switching apparatus 1 is fastened to the mating member 100 by passing the bolt 300 through the through-hole 13h of the fixing portion 13. The sealing member 40 is compressed as the bolt 300 is fastened, and the adhesiveness of the sealing member 40 between the outer case 10 and the inner case 20 and the mating member 100 is enhanced.

When the sealing member 40 is compressed by fastening using the bolt 300, the fastening is completed at the position where the protruding surface 13a of the fixing portion 13 contacts the mating member 100. At that time, the thickness t2 of the sealing member 40 becomes equal to the protrusion height h1 of the fixing portion 13. In other words, the contact of the protruding surface 13a of the fixing portion 13 with the mating member 100 serves as a stopper for the fastening using the bolt 300, preventing excessive compression of the sealing member 40. Setting the protrusion height h1 of the fixing portion 13 and the thickness t1 of the sealing member 40 allows for stably setting the compressibility of the sealing member 40, thereby stabilizing the watertightness using the sealing member 40.

### Second Embodiment

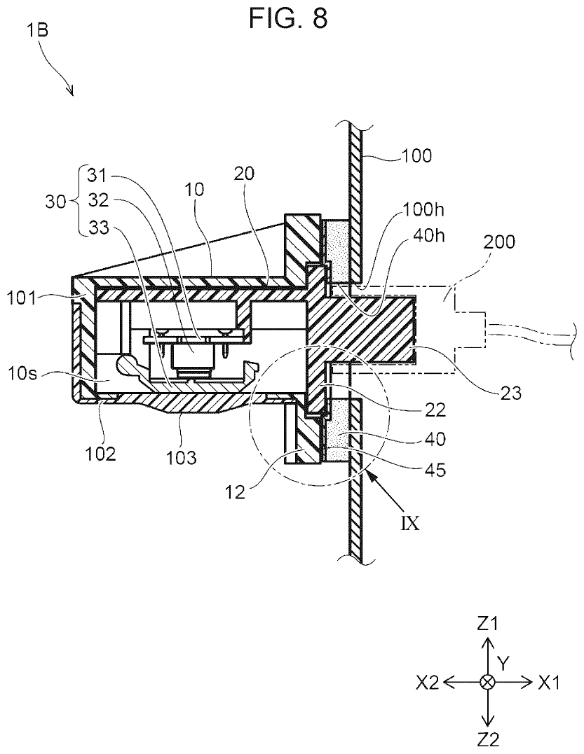

FIG. 8 is a cross-sectional view of an example of a switching apparatus according to a second embodiment.

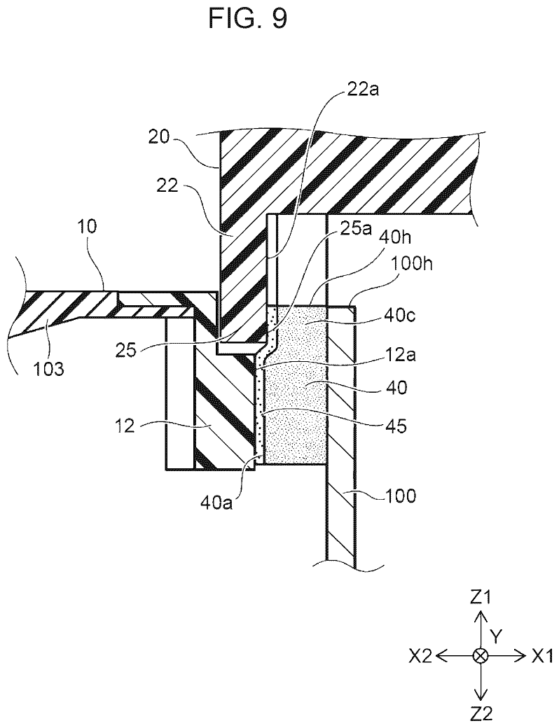

FIG. 9 is a fragmentary enlarged cross-sectional view of the switching apparatus according to the second embodiment. FIG. 9 is an enlarged cross-sectional view of portion B illustrated in FIG. 8.

In the switching apparatus 1B according to the second embodiment, the flange 22 of the inner case 20 may include an opposing portion 25 facing the mating member 100 via the sealing member 40 when attached to the mating member 100. The opposing portion 25 may have a protruding portion 25a protruding from the recessed portion 11 in the X1-direction in a state before the switching apparatus 1B is attached to the mating member 100. In other words, the protruding portion 25a protrudes in the X1-direction relative to the attaching surface 12a of the attaching portion 12 of the outer case 10, with the flange 22 of the inner case 20 fitted in the recessed portion 11 of the outer case 10.

The protrusion of the protruding portion 25a in this manner causes the protruding portion 25a to be strongly pushed by the mating member 100 rather than the attaching portion 12 when the switching apparatus 1 is attached to the mating member 100. For this reason, a portion 40c of the sealing member 40 facing the protruding portion 25a is compressed more than the other portion, increasing watertightness. Therefore, the possibility that water enters the interior of the mating member 100 can be decreased.

In particular, the portion 40c of the sealing member 40 is proximal to the hole 100h of the mating member 100. By enhancing the watertightness at the portion 40c proximal to the hole 100h, the ingress of water droplets or the like into the interior of the mating member 100 through the hole 100h can be effectively reduced or eliminated. From the perspective of ensuring high watertightness, the protruding portion 25a is preferably provided around the entire periphery of the flange 22 as viewed in the X-direction.

### Third Embodiment

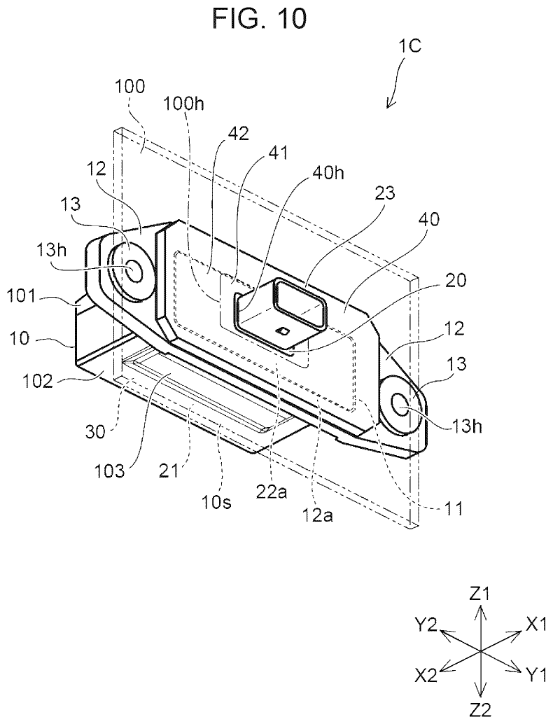

FIG. 10 is a perspective view of an example of a switching apparatus according to a third embodiment.

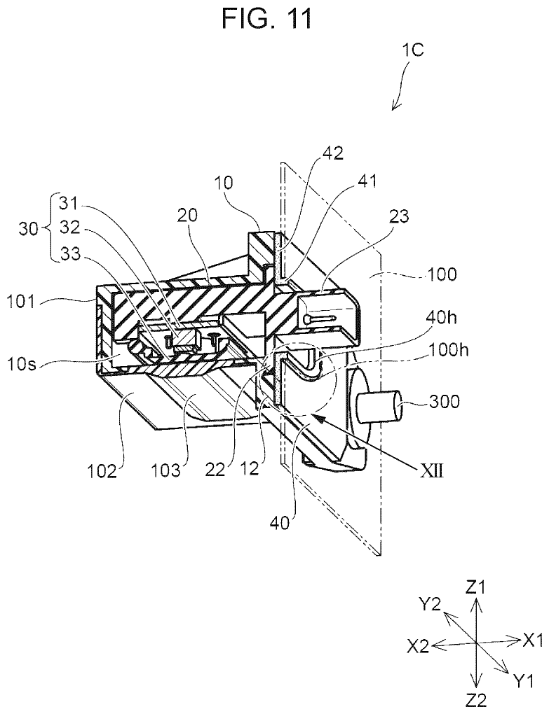

FIG. 11 is a perspective cross-sectional view of an example of the switching apparatus according to the third embodiment.

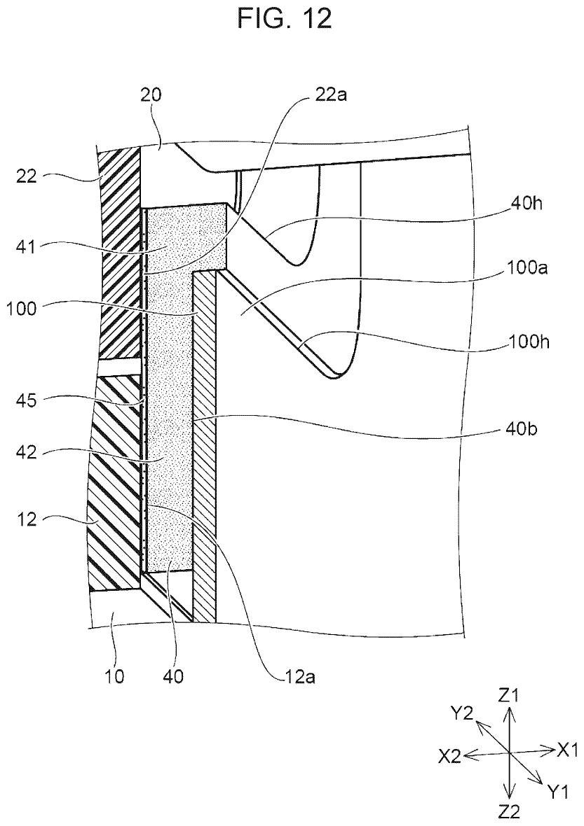

FIG. 12 is a fragmentary enlarged perspective cross-sectional view of the switching apparatus according to the third embodiment. FIG. 12 is an enlarged perspective cross-sectional view of portion C illustrated in FIG. 11.

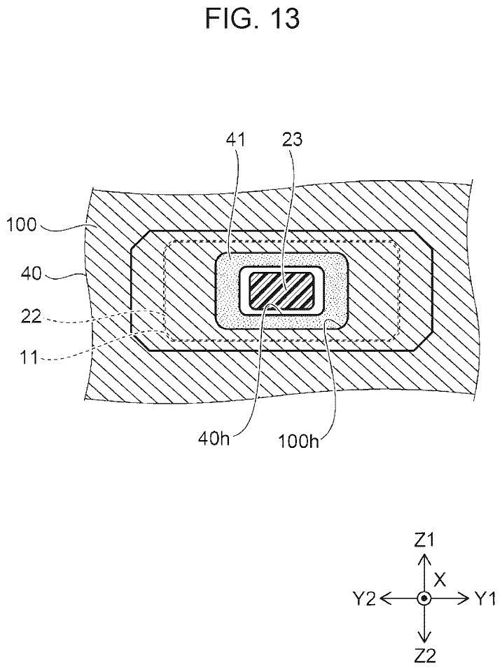

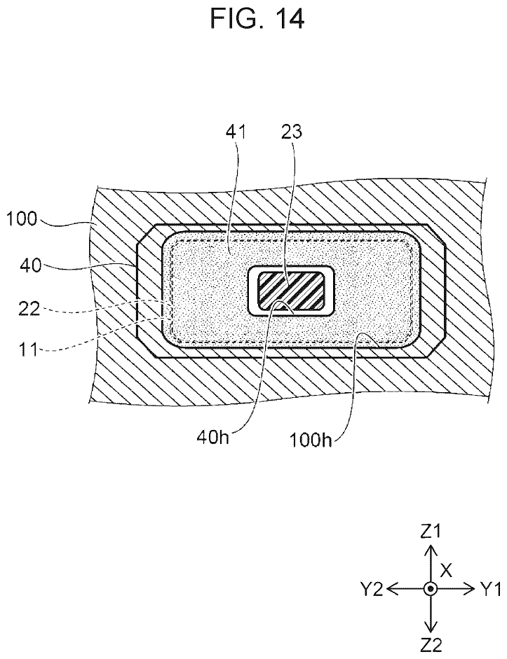

FIGS. 13 and 14 are schematic diagrams illustrating the positional relationship among the flange, the sealing member, and the mating member as viewed in the X-direction.

FIG. 10 illustrates the switching apparatus 1C according to this embodiment before attached to the mating member 100, and FIGS. 11 and 12 illustrate the switching apparatus 1C after attached to the mating member 100 for the convenience of description.

In the switching apparatus 1C of this embodiment, the surface (opposing surface 40b) of the sealing member 40 facing the mating member 100 may include a non-contact portion 41 that is not in contact with the mating member 100. This non-contact portion 41 may be provided around the through-hole 40h as viewed in the X-direction.

The fact that the sealing member 40 has the non-contact portion 41 indicates that the mating member 100 has an opening (hole 100h) wider than the through-hole 40h. Because of this, when the switching apparatus 1C is attached to the mating member 100, the edge (an edge portion 100a) of the hole 100h of the mating member 100 comes into contact with the sealing member 40 to increase the contact pressure.

A contact portion 42 of the sealing member 40 that contacts the mating member 100 is pushed, and the non-contact portion 41 is not pushed. In other words, since the non-contact portion 41 is not compressed, the non-contact portion 41 is swelled relative to the contact portion 42, and as a result, the edge of the edge portion 100a of the hole 100h is covered with the contact portion 42.

Since the sealing member 40 is pushed by the edge portion 100a of the hole 100h of the mating member 100 at high contact pressure to cover the edge of the edge portion 100a of the hole 100h with the non-contact portion 41, infiltration of water to the mating member 100 in the X1-direction can be prevented even if water infiltrates between the sealing member 40 and the mating member 100.

As illustrated in FIG. 14, the entire flange 22 may overlap with the non-contact portion 41 as viewed in the X-direction. When the mating member 100 pushes the sealing member 40, the pressure of the edge portion 100a of the hole 100h of the mating member 100 is highest. The sealing member 40 is provided so as to cover the gap between the opening edge of the outer case 10 (the peripheral edge of the recessed portion 11) and the peripheral edge of the flange 22 of the inner case 20. The portion covering the gap ensures waterproofness (prevention of water ingress into the housing space 10s of the outer case 10). Disposing the sealing member 40 so that the portion with the highest pressure is located outside the portion covering the gap reduces the possibility that water approaches the waterproof portion. For this reason, by disposing the portion with the highest watertightness around the flange 22 as viewed in the X-direction, the possibility that water may enter the recessed portion 11 can be reduced.

### Fourth Embodiment

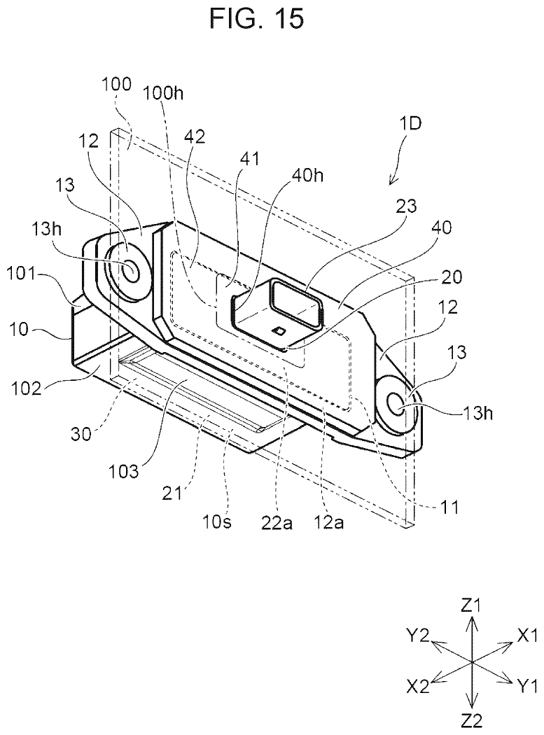

FIG. 15 is a perspective view of an example of a switching apparatus according to a fourth embodiment.

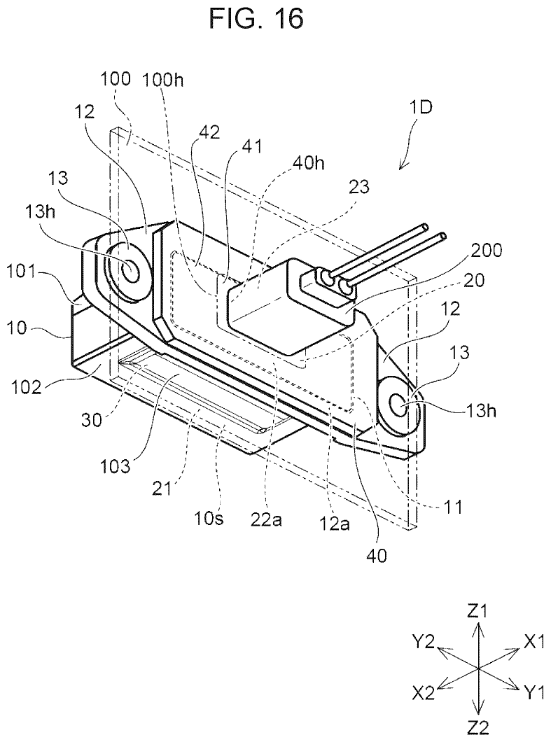

FIG. 16 is a perspective view of the switching apparatus according to the fourth embodiment illustrating a state in which a connector is connected thereto.

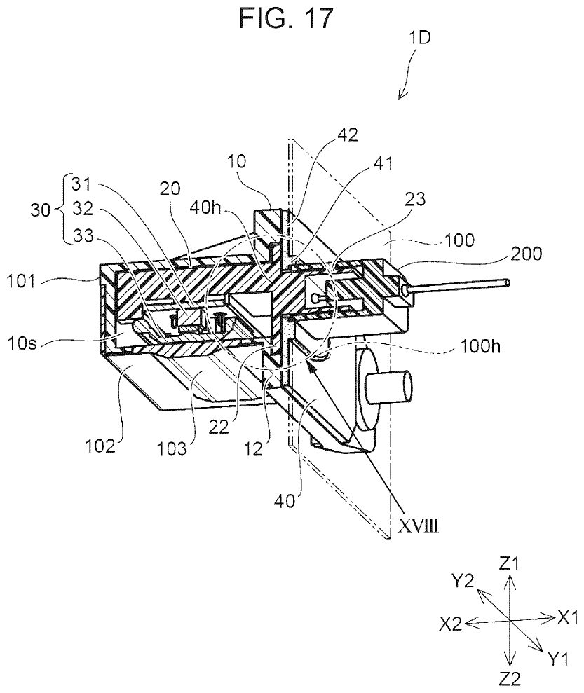

FIG. 17 is a perspective cross-sectional view of the switching apparatus according to the fourth embodiment illustrating a state in which a connector is connected thereto.

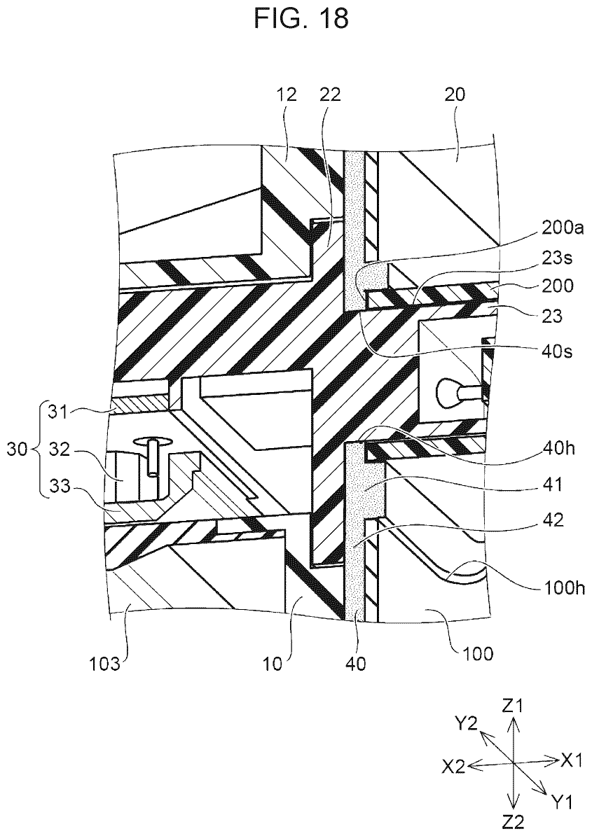

FIG. 18 is a fragmentary enlarged perspective cross-sectional view of the switching apparatus according to the fourth embodiment. FIG. 18 is an enlarged perspective cross-sectional view of portion D illustrated in FIG. 17.

FIG. 15 illustrates the switching apparatus 1D according to this embodiment before attached to the mating member 100, and FIGS. 16 to 18 illustrate the switching apparatus 1D after attached to the mating member 100 for the convenience of description.

In the switching apparatus 1D according to this embodiment, a side surface 40s of the through-hole 40h of the sealing member 40 may be in contact with a protruding side 23s of the connecting terminal 23. In other words, the size of the through-hole 40h as viewed in the X-direction is substantially equal to the size of the outer periphery of the connecting terminal 23. Therefore, when the connecting terminal 23 is inserted into the through-hole 40h, the side surface 40s of the through-hole 40h and the protruding side 23s of the connecting terminal 23 come into contact with each other. This configuration can increase the shortest distance between the outer edge and the inner edge of the seal surface of the sealing member 40 (corresponding to the creepage distance for isolation), improving the watertightness.

In the switching apparatus 1D according to this embodiment, the non-contact portion 41 of the sealing member 40 is provided to a position facing an end 200a of the connector 200. With this configuration, when the connector 200 is fitted on the connecting terminal 23, the end 200a of the connector 200 comes into contact with the non-contact portion 41 of the sealing member 40 to push the non-contact portion 41. The non-contact portion 41 does not come into contact with the mating member 100 but comes into contact with the end 200a of the connector 200 to be compressed by the portion that comes into contact with the end 200a.

Thus, the sealing member 40 is compressed by the contact portion 42 and the contact portion between the non-contact portion 41 and the end 200a of the connector 200, and only the portion between the end (edge portion 100a) of the hole 100h and the connector 200 is not compressed. Accordingly, the watertightness can be enhanced by the increase in the creepage distance on the mating member 100 side of the sealing member 40.

Thus, the switching apparatuses 1, 1B, 1C, and 1D according to the embodiments allows for ensuring sufficient water-proofness, drip-proofness, and dust-proofness even with the simple structure.

Having described the above embodiments, the present invention is not limited to the examples. For example, it is to be understood that addition, deletion, or design changes of components performed by those skilled in the art on the above embodiments, as well as appropriate combinations of the features of the configurations of the embodiments, are also included within the scope of the present invention as long as they fall within the gist of the present invention.

What is claimed is:

1. A switching apparatus comprising:
an outer case including an opening that is open in a first direction;
an inner case disposed in the outer case through the opening;
a switch unit provided in the inner case; and
a sealing member,
wherein the outer case includes:
a recessed portion provided around the opening; and
an attaching portion extending in a flange shape around the recessed portion,
wherein the inner case includes:
an insertion portion disposed in the outer case through the opening, the switch unit being disposed in the insertion portion;
a plate-like flange connected to the insertion portion; and
a connecting terminal provided at an opposite side of the flange from the insertion portion, the connecting terminal protruding in the first direction, and
wherein the sealing member is disposed astride a surface of the flange where the connecting terminal is provided and an attaching surface around the recessed portion of the attaching portion, the sealing member covering an exposed portion of the recessed portion located around the flange as viewed in the first direction.

2. The switching apparatus according to claim 1, wherein the sealing member includes a portion made of a closed-cell sponge material.

3. The switching apparatus according to claim 1, further comprising a bonding layer on a surface the sealing member facing the attaching portion and the flange.

4. The switching apparatus according to claim 1, wherein the attaching portion includes, at a portion not facing the sealing member, a fixing portion for fixing with a mating member.

5. The switching apparatus according to claim 1,
wherein the flange includes an opposing portion facing the mating member via the sealing member when attached to the mating member, and
wherein the opposing portion includes a protruding portion protruding from the recessed portion in the first direction in a state before being attached to the mating member.

6. The switching apparatus according to claim 1,
wherein the sealing member includes a through-hole passing therethrough in the first direction, and
wherein the connecting terminal is passed through the through-hole.

7. The switching apparatus according to claim 6, wherein a side surface of the through-hole is in contact with a protruding side of the connecting terminal.

8. The switching apparatus according to claim 6, wherein the surface of the sealing member facing the mating member includes a non-contact portion that does not come into contact with the mating member around the through-hole as viewed in the first direction.

9. The switching apparatus according to claim 8, wherein a whole of the non-contact portion overlaps with the flange as viewed in the first direction.

10. The switching apparatus according to claim 8, wherein a whole of the flange overlaps with the non-contact portion as viewed in the first direction.
